(19) United States
(12) Patent Application Publication
(10) Pub. No.: US 2026/0149575 A1
(43) Pub. Date: May 28, 2026

(54) METHOD OF GENERATING SIGNATURE AND SYSTEM THEREOF

(71) Applicant: SAMSUNG ELECTRONICS CO., LTD., Suwon-si (KR)

(72) Inventors: Gwangbae CHOI, Suwon-si (KR); Jisoo Kim, Suwon-si (KR); Mungyu Bae, Suwon-si (KR); Younsung Chu, Suwon-si (KR)

(73) Assignee: SAMSUNG ELECTRONICS CO., LTD., Suwon-si (KR)

(21) Appl. No.: 19/323,446

(22) Filed: Sep. 9, 2025

(30) Foreign Application Priority Data
Sep. 26, 2024 (KR) 10-2024-0131033

(51) Int. Cl. H04L 9/08; G06F 21/64

(52) U.S. Cl. CPC H04L 9/0869; G06F 21/64

(57) ABSTRACT

An embodiment of the present disclosure provides a signature generation method including obtaining a private key and a corresponding public key both associated with a storage device, dividing the private key into a plurality of unit private keys based on a processing bit unit, obtaining a first calculation number of hash calculations for deriving the public key from the private key based on the processing bit unit, obtaining a first application number of hash calculations for deriving a plurality of unit firmware signatures corresponding to each of the plurality of unit private keys based on a first random number, determining whether a first remaining number that is a difference between the first application number and the first calculation number, is less than or equal to a preset first threshold, and, and generating a firmware signature based on the plurality of unit firmware signatures based on the determining.

### CROSS-REFERENCE TO RELATED APPLICATIONS

This application claims priority to and the benefit of Korean Patent Application No. 10-2024-0131033, filed in the Korean Intellectual Property Office on Sep. 26, 2024, the entire disclosure of which is incorporated herein by reference in its entirety.

### BACKGROUND

The present disclosure relates to a signature generation method and a signature generation system.

A storage device may be driven by firmware. Firmware is a software embedded in a specific hardware device, and is a type of operating system that controls and operates the hardware. The firmware may be stored and updated in read only memory (ROM) or programmable ROM (PROM) within a storage device.

The storage device may verify validity of the firmware. A time it takes for a storage device to verify its firmware may affect a boot time of the storage device. Accordingly, methods to reduce the boot time of storage device is needed.

### SUMMARY

Some embodiments attempt to provide a signature generation method for generating a firmware signature that reduces a time required for firmware verification, a storage device including the firmware signature, and a system including the storage device.

An embodiment of the present disclosure provides a signature generation method including obtaining a private key and a public key corresponding to the private key, the private key and the public key being associated with a storage device; dividing the private key into a plurality of unit private keys based on a processing bit unit; obtaining a first calculation number of hash calculations for deriving the public key from the private key based on the processing bit unit; generating a first random number; obtaining a first application number of hash calculations for deriving a plurality of unit firmware signatures based on the first random number, wherein each unit firmware signature is associated with a respective unit private key from the plurality of unit private keys based on the first random number; determining whether a first remaining number that is a difference between the first application number and the first calculation number, is less than or equal to a preset first threshold; and upon determining that the first remaining number is less that the preset first threshold, generating a firmware signature based on the plurality of unit firmware signatures.

An embodiment of the present disclosure provides a signature generation system including random number generator configured to generate multiple random values; a hash circuit configured to generate a first digest based on a first random value among the multiple random values and firmware data; a key generator configured to obtain a first private key and a first public key, the first public key associated with the first private key, and the first private key and the first public key being associated wo firmware data; a signature generator configured to: calculate a first application number of hash calculations for deriving a first firmware signature from the first private key based on a first random number, and based on the first application number is greater than or equal to a preset first threshold, generate a first firmware signature based on the first digest and the first private key; and a storage device configured to store the first firmware signature and the first public key.

An embodiment of the present disclosure provides a storage device including a non-volatile memory comprising firmware data and a firmware signature generated based on a first private key; and a storage controller configured to: calculate a first remaining number of hash calculations for deriving a first public key associated with the first private key from the firmware signature based on the firmware data and a first random number, generate a first candidate public key based on the firmware signature, the firmware data, and the first random number, and verify the firmware data based on a comparison of the first candidate public key and the first public key, wherein the first remaining number is less than or equal to a preset first threshold.

### BRIEF DESCRIPTION OF DRAWINGS

FIG. 1 illustrates a storage device according to an embodiment.

FIG. 2 illustrates a flowchart showing a firmware verification process according to an embodiment.

FIG. 3 is a diagram illustrating of a pair of private key and public key according to an embodiment.

FIG. 4 illustrates a firmware image according to an embodiment.

FIG. 5 is a diagram illustrating firmware generation according to an embodiment.

FIG. 6 is a diagram illustrating a computing device according to an embodiment.

FIG. 7 illustrates portions of a private key and a public key depending on LM-OTS according to an embodiment.

FIG. 8 illustrates a signature generation process according to an embodiment.

FIG. 9 illustrates a private key and a public key of WOTS+ (Winternitz One-Time Signature Plus), which is part of XMSS (extended Merkle Signature Scheme), according to an embodiment.

FIG. 10, FIG. 11, and FIG. 12 illustrate graphs showing occurrence probability according to the number of hash calculations according to an embodiment.

FIG. 13 illustrates a block diagram showing an example of applying a storage device according to an embodiment to an SSD (solid-state drive) system.

### DETAILED DESCRIPTION

In the following detailed description, certain embodiments of the present disclosure have been shown and described. It is understood that the embodiments are described simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. In a flowchart described with reference to the drawings, an order of operations may be changed, several operations may be merged, some operations may be divided, and specific operations may not be performed.

In addition, expressions written in the singular may be construed in the singular or plural unless an explicit expression such as “one” or “single” is used. Terms including ordinal numbers such as first, second, and the like will be used only to describe various component and are not to be interpreted as limiting these components. These terms may be used for the purpose of distinguishing one constituent element from other constituent elements.

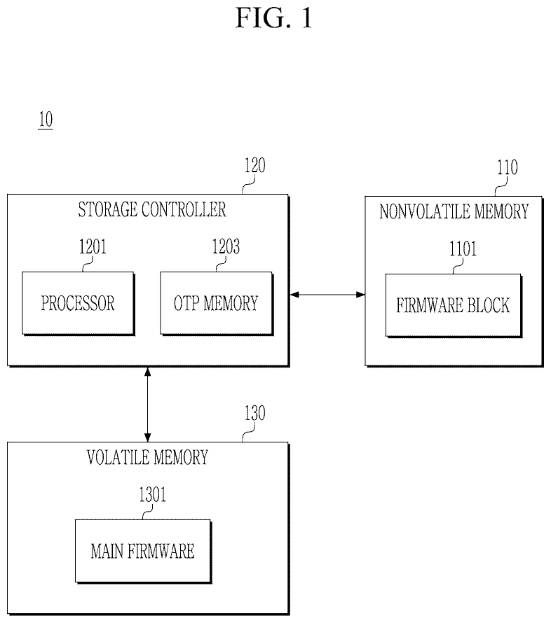

FIG. 1 illustrates a storage device according to an embodiment.

As shown in FIG. 1, the storage device 10 may include a non-volatile memory 110, a storage controller 120, and a volatile memory 130.

The non-volatile memory 110 may include a plurality of memory cells. The memory cells may store data. The non-volatile memory 110 may operate under control of the storage controller 120. In some embodiments, the non-volatile memory 110 may be a NAND flash memory.

The non-volatile memory 110 may receive a command and an address from the storage controller 120, and may perform an operation indicated by the command for a region selected by the address. The non-volatile memory 110 may perform at least one of a program operation (i.e., write operation) for storing data in a region selected by an address, a read operation for reading data, and an erase operation for deleting data.

In some embodiments, the non-volatile memory 110 may include a firmware block 1101. The firmware block 1101 may store main firmware used for an operation of the storage device 10. In some embodiments, the main firmware may store boot code. The storage controller 120 may control a general operation of the storage device 10.

In some embodiments, the storage controller 120 may load the main firmware stored in the firmware block 1101 into the volatile memory 130 when power is applied to the storage device 10. The storage controller 120 may verify the loaded main firmware 1301. In embodiments, when the main firmware has been verified, the storage controller 120 may execute the loaded main firmware 1301. However, when the main firmware is determined to be unverified, the storage controller 120 may not execute the main firmware loaded into volatile memory, and determine it to be unverified main firmware 1301.

In some embodiments, the loaded main firmware 1301 may include a memory interface layer that controls communication between the storage controller 120 and the non-volatile memory 110.

In some embodiments, the storage controller 120 may control the nonvolatile memory 130 to perform the write operation, the read operation, or the erase operation (also known as delete operation). The storage controller 120 may provide a write command, an address, and data to the nonvolatile memory 130 during the write operation. The storage controller 120 may provide a read command and an address to the non-volatile memory 130 during the read operation. The storage controller 120 may provide an erase command and an address to the nonvolatile memory 130 during the erase operation.

In some embodiments, the storage controller 120 may include a processor 1201 and a one-time programmable (OTP) memory 1203.

The processor 1201 may control a general operation of the storage controller 120.

For example, the processor 1201 may be implemented as at least one of various processing units such as a central processing unit (CPU), an application processor (AP), and a graphics processing unit (GPU). In some embodiments, the processor 1201 may be implemented as an integrated circuit, such as a system on chip (SoC).

In some embodiments, the processor 1201 may control loading of the main firmware stored in the firmware block 1101 into the volatile memory 130.

The processor 1201 may execute the main firmware 1301. In some embodiments, the main firmware 1301 may include a plurality of application programming interfaces (APIs). Each of the multiple APIs may contain multiple main codes. In some embodiments, the processor 1201 may execute the main firmware 1301 to control the nonvolatile memory 130 to perform the write operation, the read operation, and the erase operation.

The processor 1201 may verify the main firmware 1301. In some embodiments, the processor 1201 may verify the main firmware 1301 when power is supplied to the storage device 10 or when the storage device 10 is reset. In some embodiments, the processor 1201 may load a boot code within the main firmware 1301 into the volatile memory 130. In embodiments, the processor 1201 may sequentially verify multiple boot codes within the main firmware 1301. In some embodiments, firmware verification may be performed as part of a boot procedure by a ROM code executed by the processor 1201, without an operation of existing firmware.

In some embodiments, the main firmware 1301 may be firmware signed with a cryptographic private key based on an encryption algorithm. For example, the encryption algorithm may include but are not limited to, Leighton-Micali Signature (LMS), extended Merkle Signature Scheme (XMSS), etc.

As described in detail below, a manufacturer may generate firmware code, and may generate a firmware signature for the firmware code. Then, the manufacturer may generate a hash value for the firmware code, and may generate the firmware signature by encrypting the hash value of the firmware code using a firmware private key. In some embodiments, a ciphertext of the hash value of the firmware code may be generated as the firmware signature. That is, a manufacturer may use a one-way function to output a unique value that uniquely identifies the firmware code. For example, a manufacturer may generate a hash value for a firmware code by inputting the firmware code into a predetermined hash function.

In some embodiments, the firmware private key that is used to generate the firmware signature may correspond to a firmware public key stored in the main firmware 1301. A manufacturer may generate a firmware signature using a firmware private key that corresponds to a firmware public key embedded in a running firmware of an electronic device. In some embodiments, the main firmware 1301 may include a firmware signature generated based on a firmware private key and a public key corresponding to the firmware private key. In embodiments, the public key may be stored in the OTP memory 1203.

In some embodiments, the processor 1201 may verify the main firmware 1301 based on the firmware signature and the corresponding firmware public key. For example, the processor 1201 may verify the main firmware 1301 based on the firmware signature and the firmware public key.

The OTP memory 1203 may store data related to the firmware to be verified. For example, the OTP memory 1203 may include a firmware public key corresponding to a firmware private key used to generate the firmware signature.

The volatile memory 130 may temporarily store provided data, or may temporarily store data read from nonvolatile memory 110. In some embodiments, the volatile memory 130 may be a dynamic random access memory (DRAM) or a static random access memory (SRAM). In some embodiments, the volatile memory 130 may be positioned outside the storage controller 120, or may be positioned within the storage controller 120.

In some embodiments, the volatile memory 130 may store the main firmware 1301 read from the firmware block 1101 of the non-volatile memory 110.

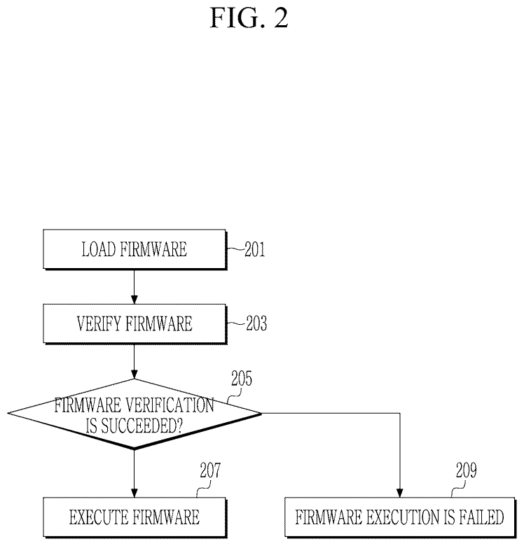

FIG. 2 is an exemplary flowchart of a process of firmware verification, according to an embodiment.

At operation 201, the processor 1201 may load firmware.

When power is supplied to the storage device 10 or the storage device 10 is reset, the processor 1201 may execute the firmware block 1101 of the non-volatile memory 110. The processor 1201 may load the main firmware 1301 from the non-volatile memory 110 into the volatile memory 130 by executing the firmware block 1101.

At operation 203, the processor 1201 may verify firmware.

In some embodiments, the processor 1201 may verify the main firmware 1301 using a predetermined hash algorithm or hash function. For example, the predetermined hash algorithm or hash function may be the same as a hash algorithm or hash function used when computing the firmware signature and a corresponding firmware public key stored within the main firmware 1301. In some embodiments, data regarding a predetermined hash algorithm or hash function may be included in a firmware or the OTP memory 1203 during manufacturing of the storage device 10.

In some embodiments, at operation 205, the processor may determine whether firmware verification has succeeded. The processor 1201 may generate a candidate public key based on a firmware signature and firmware data, and may compare it with a pre-stored firmware public key. The processor 1201 may determine that firmware verification is successful if the candidate public key and the firmware public key are identical. If the candidate public key and the firmware public key are different, the processor 1201 may determine that the firmware data has been modified and that the firmware verification has failed.

In some embodiments, the firmware public key may be stored in a ROM and/or the OTP memory 1203 of the storage device 10. For example, the firmware public key may be stored as part of a ROM code within the ROM.

Reducing the time it takes for the processor 1201 to generate the candidate public key based on the firmware signature and the firmware data, effectively reduces the time it takes for the processor 1201 to load the firmware and execute the firmware.

If verification is successful (e.g., at operation 205), at operation 207, the processor 1201 may execute the firmware.

In some embodiments, the processor 1201 may determine that the firmware is authenticated firmware including firmware code manufactured by a manufacturer.

If the verification fails (e.g., at operation 205), the processor 1201 may fail to execute the firmware at operation 209.

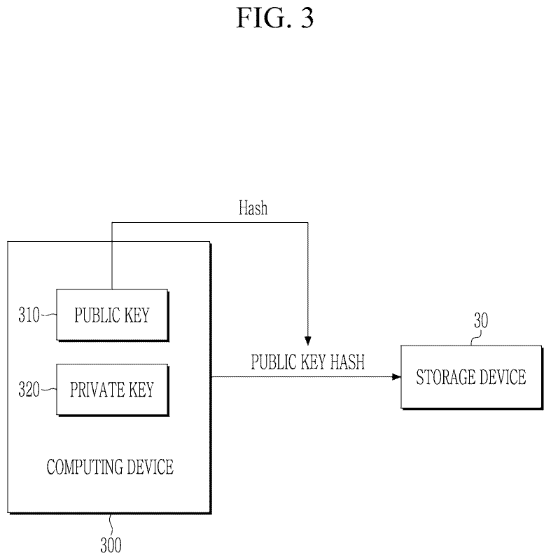

FIG. 3 illustrates a view for describing an example of a pair of private key and public key according to an embodiment.

In some embodiments, the manufacturer of the firmware within the storage device may use the computing device 300 to generate a unique pair of private key 320 and public key 310. The computing device 300 may be, e.g., a hardware secure module (HSM).

The manufacturer may store the private key 320 in the computing device 300, and may hash the public key 310 to generate a hash value of the public key 310. Furthermore, the manufacturer may provision the hash value of the public key 310 to the storage device 30. In some embodiments, the hash value of the public key 310 may be stored in at least one of the volatile memory 130 (FIG. 1) and the OTP memory 1203 (FIG. 1) of the storage 10.

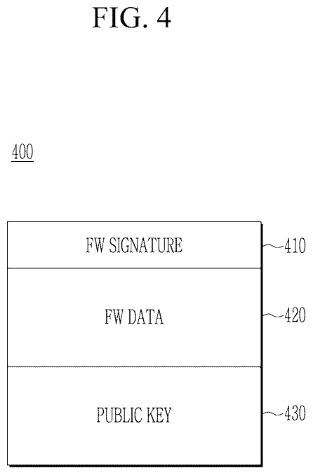

FIG. 4 illustrates a firmware image according to an embodiment.

As illustrated in FIG. 4, the firmware image 400 may include a firmware signature 410 (referred to in FIG. 4 as “FW Signature”), firmware data 420 (referred to in FIG. 4 as “FW Data”), and a public key 430.

The firmware signature 410 may include data necessary to perform verification of the firmware image 400. The firmware signature 410 may be a hash of the firmware image 400 encrypted using a private key. When the private key is used to generate the firmware signature 410, the corresponding public key 430 may be attached as metadata along with the firmware signature 410.

The firmware signature 410 may have different information depending on an encryption algorithm applied to the firmware image 400. In some embodiments, the firmware signature 410 may be generated based on a key generation method for Leighton-Micali One-Time Signature (LM-OTS) for Leighton-Micali Signature (LMS). The LM-OTS signature may be used to verify authenticity of a message by linking a secret private key to a shared public key.

The LMS system may combine the LM-OTS system and the Merkle tree structure. For example, each pair of LMS public and private keys may be associated with a binary Merkle tree. The Merkle tree may be a nonlinear binary data structure that has a leaf node, a group of intermediate nodes containing at least one intermediate node, and a root node. The leaf node may be a node positioned at a very bottom of the Merkle tree. Each leaf node may include a hash value of the firmware data. For example, a leaf node may include a public key to be used to sign a particular message. Each intermediate node in the Merkle tree may include hash values generated by combining the hash values of the leaf nodes. The intermediate node may be connected to two subnodes, and may include a new hash value by combining hash values of the subnodes. The root node may be a final node of the Merkle tree. The root node may be a collection of hash values for all firmware data in the Merkle tree structure.

For example, when verification is performed according to a specific encryption algorithm for the firmware image 400, a result of signing the hash value obtained by applying a hash function to the firmware data 420 with a private key may be included in the firmware signature 410. The firmware signature 410 may be verified based on the corresponding public key 430.

In some embodiments, the firmware signature 410 may include information related to the hash function that the computing device 300 used to generate the firmware signature 410. For example, the information related to the hash function may include a type of the hash function, processing bit units to which the hash function is applied, values of adjacent nodes (i.e., other nodes that share an upper node with the node) on a path from a leaf node to an intermediate node corresponding to the firmware signature 410, a random number value used to generate the firmware signature 410, etc.

The firmware data 420 may include a firmware program code.

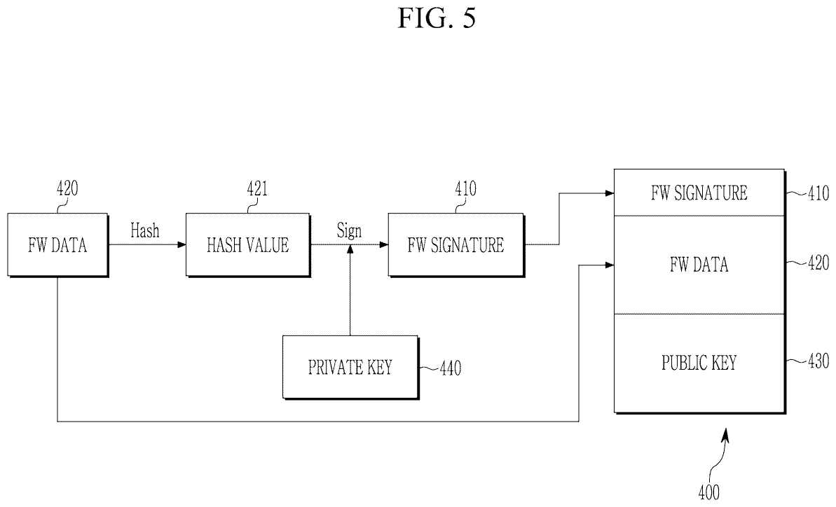

FIG. 5 illustrates a process of firmware generation according to an embodiment.

In some embodiments, the firmware image 400 may be generated by a manufacturer of the storage device. In embodiments, the computing device 300 (FIG. 3) of the manufacturer may hash the firmware data 420 to generate a hash value 421. The computing device 300 may generate the firmware signature 410 by signing the hash value 421 with a private key 440. Then, the computing device 300 may attach the firmware signature 410 together with a public key 430 that corresponding to the private key to the firmware data 420 to generate the firmware image 400.

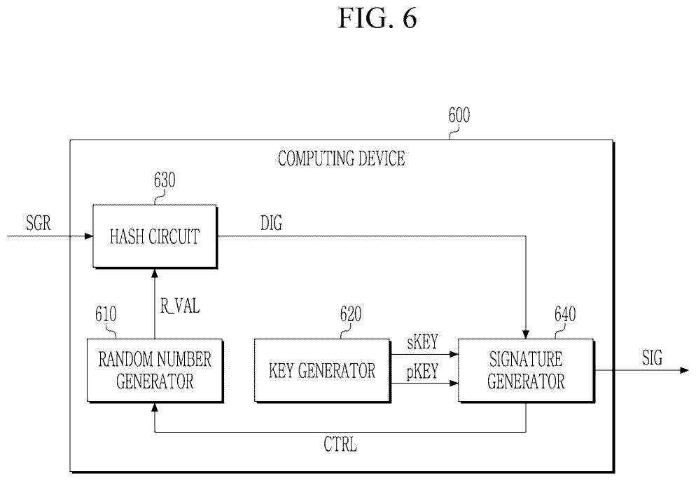

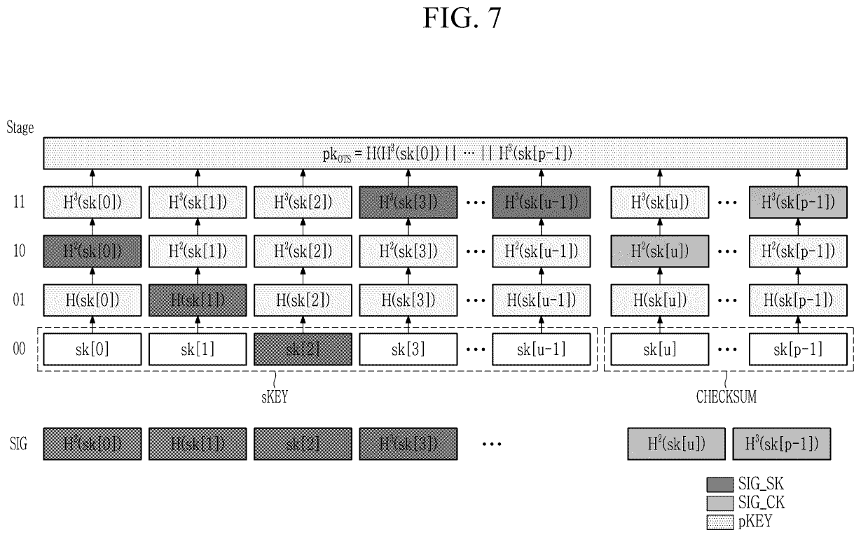

FIG. 6 illustrates a computing device according to an exemplary embodiment. FIG. 7 illustrates portions of a private key and a public key depending on LM-OTS according to an embodiment.

As shown in FIG. 6, the computing device 600 may include a random number generator 610 (referred to as “random value generator” in FIG. 6), a key generator 620, a hash circuit 630, and a signature generator 640.

The random number generator 610 may generate a random number R_VAL based on a control signal CTRL. The random number generator 610 may limit random number R VAI to have a maximum number of bits. For example, the random number generator 610 may generate a value that is smaller than a maximum value calculated based on the set maximum number of bits as the random number R_VAL. The random number generator 610 may pass the random number R_VAL to the hash circuit 630.

The key generator 620 may generate a key pair including a private key sKEY and a public key pKEY.

In some embodiments, the key generator 620 may generate the key pair based on a key generation method of LM-OTS for LMS. The private key sKEY may be a unique value corresponding to the storage device 10 storing a firmware image.

A format of the LM-OTS private key may be defined by the computing device 300 (FIG. 3). In some embodiments, a hash function may be used to compute the LM-OTS private key. The hash function may include, e.g., a secure hash algorithm (SHA) (e.g., SHA-256, SHA-256/192, SHAKE256/256, and SHAKE256/192). The hash function may input a variety of objects that a computer can interpret and output different sized outputs depending on the hash algorithm.

For example, the private key sKEY may be a k-bit data. In embodiments, k may be determined based on an output length of the hash function. For example, when using a SHA-256 hash function, k may be 256 bits (32 bytes). The private key sKEY may include a type code indicating a LM-OTS algorithm type, an array including an n-byte string for indicating a type of hash function used in the LM-OTS algorithm, a parameter including a 16-byte string indicating a Merkle tree structure used with the LM-OTS algorithm, and a 32-bit integer parameter indicating a leaf position within the Merkle tree structure.

The key generator 620 may divide the private key sKEY based on a preset number of valid bits and a processing bit unit. The number of valid bits may indicate the number of bits used by the key generator 620 among output values resulting from applying the hash function. The processing bit unit may be a bit unit for processing the output value, which is, 2 bits, 4 bits, 8 bits, etc., for example. The key generator 620 may generate multiple unit private keys by dividing the private key sKEY.

Referring now to FIG. 7, the key generator 620 may generate the unit private keys sk[0], sk[1], . . . , and sk[u−1]) by dividing the private key sKEY based on the preset number of valid bits and the processing bit unit. In embodiments, the number u of the unit private keys sk[0], sk[1], . . . , and sk[u−1] may be proportional to a value of the number of effective bits divided by the processing bit unit.

In some embodiments, the key generator 620 may determine a number of hash function calculations required to generate the public key pKEY from the private key sKEY based on a preset number of valid bits and a processing bit unit. The key generator 620 may determine a number of stages of the hash function based on the processing bit unit. The key generator 620 may further determine a number of unit private keys, which are units to which the hash function is applied, based on the number of valid bits and the processing bit unit.

For example, as shown in FIG. 7, if the processing bit unit is 2 bits, it may include 4 stages corresponding to 00, 01, 10, and 11. The key generator 620 may apply a preset hash function to each of the multiple unit private keys sk[0], sk[1], . . . , and sk[u−1] according to four stages stage 00, stage 01, stage 10, and stage 11. In FIG. 7, the preset hash function may be expressed as H for convenience of description, but the present disclosure is not limited thereto, and the hash function may be a variety of functions.

For example, the preset hash function may be a function that takes into account at least one element of the corresponding unit private key. In some embodiments, the preset hash function may take into account I or q. In the present disclosure, I may be a type code indicating a type of LM-OTS algorithm used by the key generator 620 to generate the private key sKEY and the public key pKEY. Here, q may be a value indicating a leaf position within the corresponding Merkle tree structure. For example, a unit firmware signature H³(sk[u−1]) corresponding to a unit private key sk[u−1] may indicate H(I∥u32str(q)∥u16str(u−1)∥u8str(1)∥H(I∥u32str(q)∥u16str(u−1)∥u8str(0)∥sk[u−1]))∥H(I∥u32str(q)∥u16str(u−1)∥u8str(0)∥sk[u−1])).

In some embodiments, the key generator 620 may apply a hash function reflecting a preset value corresponding to each stage to distinguish each stage. Thereafter, the key generator 620 may generate the public key pKEY by applying the hash function to a result value obtained by applying the hash function in the last 11 stages. In some embodiments, the public key pKEY may be a single public key in the Merkle tree structure.

The hash circuit 630 may receive a firmware signature generation request SGR, and may generate a digest DIG for the signature generation request SGR. The digest DIG may refer to a hash value generated based on a hash algorithm.

Specifically, the hash circuit 630 may generate the digest DIG based on Equation 1 below.

$$Q = H ( I ‖ u 32 str ( q ) ‖ u 16 str ( D\_MESG ) ‖ C ‖ message ) \qquad Equation 1$$

In Equation 1, Q may be a value indicating the digest DIG. The digest DIG may indicate the number of hash calculations to be applied to generate a signature for each of the unit private keys sk[0], sk[1], . . . , and sk[u−1]. I may be a type code indicating a type of LM-OTS algorithm used by the key generator 620 to generate the private key sKEY and the public key pKEY. For example, I may include the type of hash function used by the key generator 620, the processing bit unit, etc. u32str(q) may be a value indicating a leaf position within the corresponding Merkle tree structure. u16str(D_MESG) may be a preset value corresponding to each stage to distinguish multiple stages in the LM-OTS algorithm. For example, u16str(D_MESG) may be (0x8181). C may be a random value R_VAL generated by random number generator 610. Message may be a value indicating the data to be signed (i.e. firmware data).

I, u32str(q), u16str(D_MESG), and message have constant values, so only the random value R_VAL among multiple elements used to determine the digest DIG may change unless the firmware data is tampered with.

The hash circuit 630 may transfer the digest DIG to the signature generator 640.

The signature generator 640 may receive the private key sKEY and the public key pKEY from the key generator 620. The signature generator 640 may generate a first signature SIG_SK for the private key sKEY based on the private key sKEY and the digest DIG.

The signature generator 640 may determine the number of calculations of the hash function applied to each of the unit private keys sk[0], . . . , and sk[u−1] based on the digest DIG. The signature generator 640 may generate the first signature SIG_SK by applying the hash function a determined number of calculations corresponding to each of the unit private keys sk[0], . . . , and sk[u−1]. The first signature SIG_SK may include unit firmware signatures corresponding to each of the unit private keys sk[0], . . . , and sk[u−1].

For example, the digest DIG may instruct the first unit private key sk[0] to apply two hash calculations. Furthermore, the digest DIG may instruct to apply 1 hash calculation to the second unit private key sk[1], 0 hash calculations to the third unit private key sk[2], and 3 hash calculations to the fourth unit private key sk[3].

As shown in FIG. 7, the signature generator 640 may generate a first unit firmware signature H²(sk[0]) corresponding to the first unit private key sk[0] by applying two hash calculations to the first unit private key sk[0] based on the digest DIG. The signature generator 640 may generate a second unit firmware signature H(sk[1]) corresponding to the second unit private key sk[1] by applying a single hash to the second unit private key sk[1]. The signature generator 640 may generate a third unit firmware signature sk[2] corresponding to the third unit private key (sk[2]) by applying zero hashes to the third unit private key (sk[2]). The signature generator 640 may generate a fourth unit firmware signature H³(sk[3]) corresponding to the fourth unit private key sk[3] by applying two hashes to the fourth unit private key sk[3].

In some embodiments, the signature generator 640 may generate a second signature SIG_CK for the unit check key based on the private key sKEY and the digest DIG. The second signature SIG_CK may be a checksum for the first signature SIG_SK. The checksum may be a value used to detect whether a signature has been forged. The second signature SIG_CK may include unit checksums H²(sk[u]), . . . , and H³(sk[p−1]) corresponding to each of the unit check keys sk[u], . . . , and sk[p−1]. In some embodiments, the checksum may indicate a number of calculations of a hash function that must be applied to each of the unit firmware signatures to derive public keys corresponding to the unit private keys from each of the unit firmware signatures. That is, it may a value obtained by subtracting the number of hash calculations to be applied to generate the first signature SIG_SK from a total number of calculations of the hash function. A maximum value that a checksum can have may be determined based on the number of significant bits and the processing bit unit. Accordingly, the number of bits in the checksum may be preset.

For example, as illustrated in FIG. 7, in addition to the private key sKEY, the attached unit check keys sk[u], . . . , and sk[p−1] may be check keys assigned to indicate the checksum of the unit private keys sk[0], . . . , and sk[u−1]. The unit checksums H²(sk[u]), . . . , and H³(sk[p−1]) may indicate the number of hash function calculations that should be applied to derive the public key pKEY from multiple unit firmware signatures H²(sk[0]), H(sk[1]), sk[2], H³(sk[3]), . . . , and H³(sk[u−1]). Meanwhile, in FIG. 7, at least one unit check key sk[u], . . . , and sk[p−1]) is illustrated as being used to indicate a checksum, but the number of unit check keys indicating a checksum may be different depending on a maximum value that the checksum can have.

This may be expressed by Equations 2-5 below.

$$u - ciel ( 8 * n / w ) \qquad Equation 2$$

$$v = ceil ( ( floor ( lg ( ( 2 \hat{} w - 1 ) * u ) ) + 1 ) / w ) \qquad Equation 3$$

$$ls = 16 - ( v * v ) \qquad Equation 4$$

$$p = u + v \qquad Equation 5$$

In Equations 2-5, u may indicate a number of private keys, n may indicate a length of the private key, w may indicate the processing bit unit, v may indicate a length of the check key, Is may indicate a position of the second signature SIG_CK within a firmware signature SIG, and p may be an element indicating the length of the firmware signature SIG.

Meanwhile, the signature generator 640 may control the random number generator 610 to generate a new random number value R_VAL based on the control signal when the number of hash calculations is less than a preset threshold value.

In some embodiments, the preset threshold may be determined based on an average of the number of hash calculations that the signature generator 640 applies to generate the firmware signature SIG. For example, in a case of LMOTS_SHA256_N24_W2, 150 times may be determined as the threshold. In a case of LMOTS_SHA256_N24_W8, 3300 times may be determined as the threshold.

The signature generator 640 may output the first signature SIG_SK and the second signature SIG_CK as the firmware signature SIG.

For example, as illustrated in FIG. 7, the signature generator 640 may generate a plurality of unit firmware signatures H²(sk[0]), H(sk[1]), sk[2], H³(sk[3]), . . . , and H³(sk[u−1]) corresponding to each of the unit private keys sk[0], . . . , and sk[u−1].

In some embodiments, the random number generator 610 may generate a plurality of random numbers R_VAL. In embodiments, the signature generator 640 may calculate a plurality of digests DIG and corresponding checksums based on each of the random numbers R_VAL. Thereafter, the signature generator 640 may determine, as a final firmware signature, a candidate firmware signature having a largest number of hash calculations applied to generate the firmware signature among a plurality of candidate firmware signatures generated based on each of the random numbers R_VAL.

Meanwhile, in FIG. 7, it is described that the signature generator 640 controls the random number generator 610 to change a digest Q, but the present invention is not limited thereto, and the signature generator 640 may change the digest DIG by changing a message value (i.e., firmware data) by attaching a random number value to the firmware data.

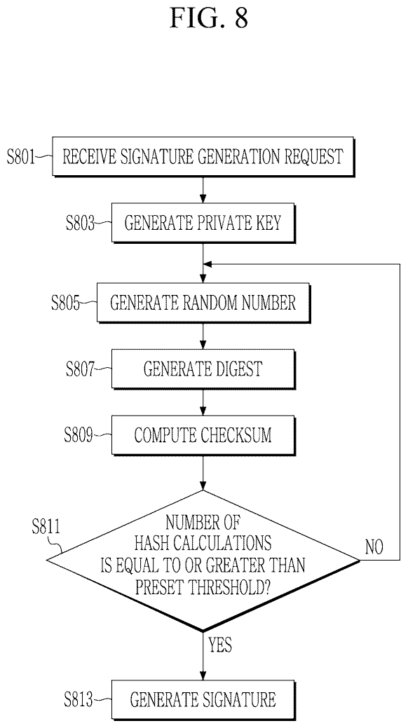

FIG. 8 illustrates a signature generation method according to an embodiment.

The hash circuit 630 may receive a signature generation request SGR (S801).

The key generator 620 may generate a private key sKEY (S803).

The key generator 620 may generate the private key sKEY and a public key pKEY corresponding to the private key sKEY based on a processing bit unit.

The random number generator 610 may generate a random number value R_VAL (S805).

The hash circuit 630 may generate a digest DIG (S807).

As described above, the hash circuit 630 may generate the digest DIG based on data regarding an LMS algorithm used by the key generator 620, data indicating a leaf node of an LM-OTS that includes the public key pKEY corresponding to the private key sKEY, data indicating a corresponding stage among a plurality of stages included in the LM-OTS, data to be signed (i.e., firmware data), and the random value R_VAL.

The signature generator 640 may calculate a checksum (S809).

The signature generator 640 may generate multiple unit firmware signatures H²(sk[0]), H(sk[1]), sk[2], H³(sk[3]), . . . , and H³(sk[u−1]) corresponding to each of the unit private keys sk[0], . . . , and sk[u−1] within the private key sKEY based on the digest DIG. The signature generator 640 may calculate a checksum based on the digest DIG.

The signature generator 640 may determine whether the number of hash calculations is equal to or greater than a preset threshold (S811).

Specifically, the signature generator 640 may determine the number of hash calculations to be applied to derive the public key pKEY from a first signature SIG_SK and a second signature SIG_CK.

The signature generator 640 may determine the first number of applications of a hash function to be applied to the unit private keys sk[0], . . . , and sk[u−1] to generate the first signature SIG_SK based on the digest Q. The signature generator 640 may determine the number of first calculations of a hash function to be applied to derive the public key pKEY from the unit private keys sk[0], . . . , and sk[u−1] based on the number of valid bits and the processing bit unit. The signature generator 640 may determine a first remaining number of calculations by subtracting a first application number from a total number of calculations. The first remaining number of calculations may be the number of calculations of the hash function that must be applied to the unit firmware signatures H²(sk[0]), H(sk[1]), sk[2], H³(sk[3]), . . . , and H³(sk[u−1]) to generate the public key pKEY.

The signature generator 640 may determine the number of second calculations of a hash function to be applied to derive the public key pKEY from the unit check keys sk[u], . . . , and sk[p−1] based on the number of valid bits and the processing bit unit. The signature generator 640 may determine a second number of applications of the hash function to be applied to the unit check keys sk[u], . . . , and sk[p−1]) to generate the second signature SIG_CK based on the first remaining number.

The signature generator 640 may determine a second remaining number of the hash function that must be applied to derive the public key pKEY from the unit checksums H²(sk[u]), . . . , and H³(sk[p−1]).

The signature generator 640 may compare a first sum of the first number of applications and the second number of applications with a predetermined threshold. In some embodiments, the predetermined threshold may be greater than or equal to half of the sum of the first number of calculations and the second number of calculations. The signature generator 640 may determine whether the first sum is greater than or equal to the predetermined threshold.

The signature generator 640 may determine the threshold based on the number of calculations of the hash function required depending on a type of LMS algorithm.

The sum of the first number of calculations and the second number of calculations may be determined based on the digest DIG and the checksum. That is, the sum of the first number of calculations and the second number of calculations may have a constant value. The first number of calculations may be a sum of the first number of applications and the first remaining number. The second number of calculations may be a sum of the second number of applications and the second remaining number. Accordingly, by generating the firmware signature SIG in which the sum of the first number of applications and the second number of applications is greater than or equal to a preset threshold, the storage device 10 (FIG. 1) including the firmware signature SIG may reduce the number of hash calculations performed to verify firmware data using the firmware signature SIG. Accordingly, the time required for the storage device 10 to verify firmware data may be reduced. That is, by changing values of the digest DIG and the checksum such that the computing device 300 generates the firmware signature SIG by performing more hash calculations, a time required to perform verification in the storage device 10 in the future may be reduced.

When the number of hash calculations is not greater than a preset threshold, the signature generator 640 may perform an operation $805 again. The signature generator 640 may generate a signature based on a new random value R_VAL until the number of hash calculations exceeds the preset threshold.

When the number of hash calculations is greater than a preset threshold, the signature generator 640 may perform generate a signature (S813).

Meanwhile, in FIGS. 1 to 8, the computing device 600 is described as generating a firmware signature based on the LMS system, but the present disclosure is not limited thereto, and the computing device 600 may also generate the firmware signature SIG based on an XMSS algorithm.

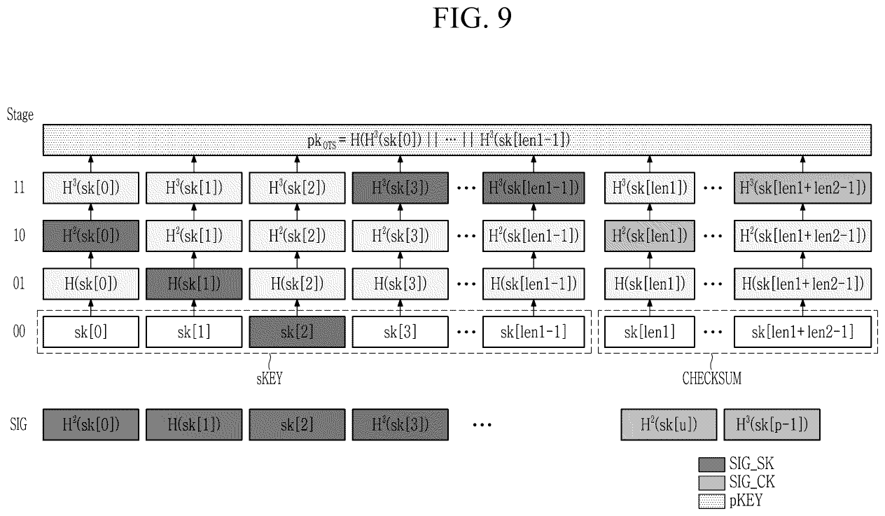

FIG. 9 illustrates a private key and a public key of WOTS+, which is part of XMSS, according to an embodiment.

Meanwhile, it is assumed that the computing device 600 generates the firmware signature SIG based on the XMSS algorithm. In this case, multiple unit private keys may generate the digest DIG through the hash circuit 630 using Expression 3.

$$byte [ n ] M ’ = H\_msg ( r ‖ getRoot ( SK ) ‖ toByte ( idx\_sig , n ) ) , M ) \qquad Equation 6$$

In Equation 6, byte[n] M′ may indicate a hash result of M′ including of n bytes. getRoot(SK) may point to a root hash value of the private key of XMSS. toByte(idx_sig, n) may point to an index of the signature within the XMSS algorithm converted to n bytes. M may be data to be signed, i.e. firmware data.

Meanwhile, unlike in the LM-OTS method where the digest DIG may be changed by changing the random value R_VAL, multiple elements used to determine the digest DIG of the XMSS algorithm may all have constant values.

This may be expressed by Equations 7-9 below.

$$len = len\_ 1 + len\_ 2 \qquad Equation 7$$

$$len\_ 1 = ceil ( 8 n / lg ( v ) ) \qquad Equation 8$$

$$len\_ 2 = floor ( lg ( len\_ 1 * ( w - 1 ) ) / lg ( v ) ) + 1 \qquad Equation 9$$

In the above Equations 7-9, n may be a length of the private key, and w may be the processing bit unit. Here, len_1 may indicate the length of the private key, and len_2 may indicate an element indicating the length of the checksum.

Accordingly, when the computing device 600 generates the firmware signature based on the XMSS algorithm, the computing device 600 may generate a plurality of candidate firmware signatures in advance based on a plurality of checksums and corresponding digests DIGs, and may determine a candidate firmware signature with a largest number of hash calculations applied to generate the firmware signature among the generated candidate firmware signatures as a final firmware signature.

In some embodiments, the computing device 600 may change the digest (DIG) by changing an M value (i.e., firmware data) by appending a random value to the firmware data.

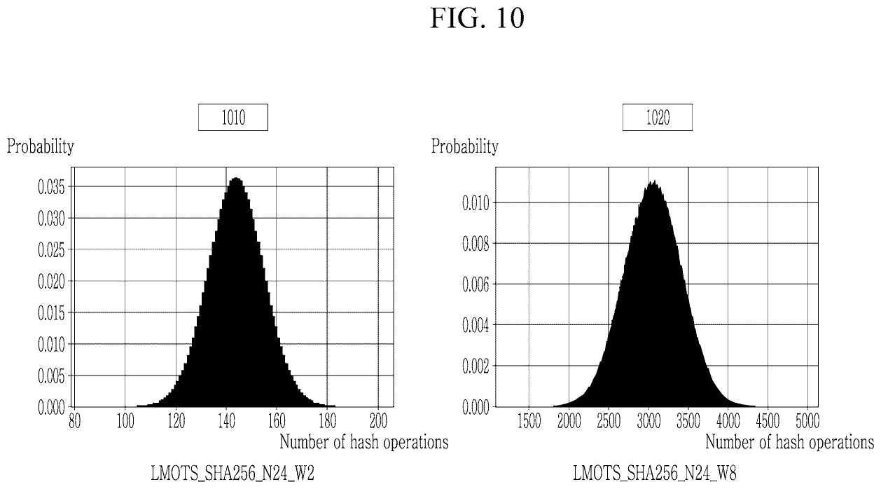

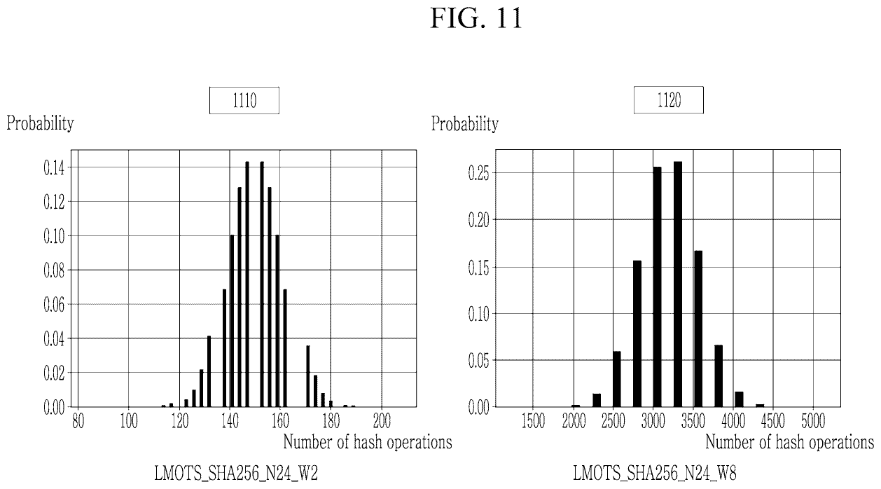

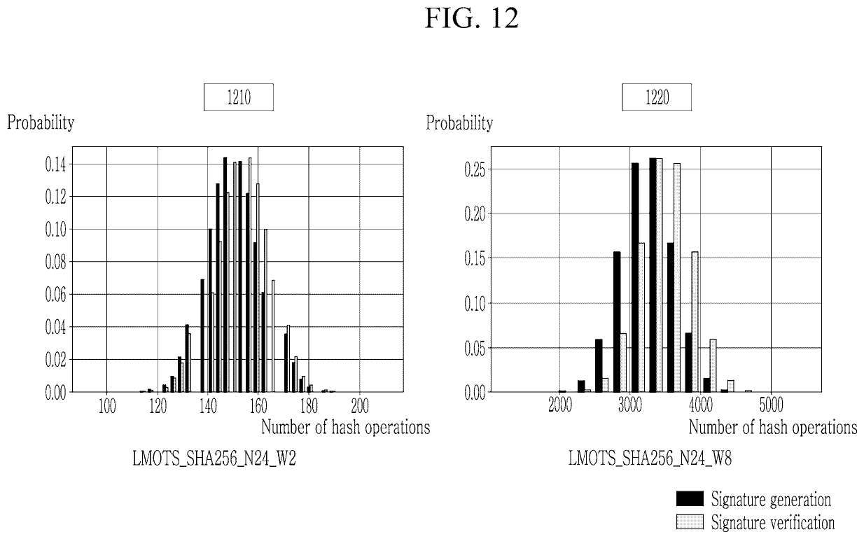

FIG. 10 to FIG. 12 illustrate graphs showing occurrence probability according to the number of hash calculations according to an embodiment.

FIGS. 10 to 12 illustrate probability graphs associated with two cases. A first case, referred to as 1010, 1110, and 1210 in FIGS. 10, 11, and 12 respectively, LMOTS_SHA256_N24_W2, in which a SHA256 algorithm is used, 24 bytes out of 32 bytes of an output value of the SHA256 algorithm are used (N=24) and the processing bit unit is 2 bits (W=2). A second case, referred to as 1020, 1120, and 1220 in FIGS. 10, 11, and 12 respectively, LMOTS_SHA256_N24_W8, in which the SHA256 algorithm is used, 24 bytes out of 32 bytes of the output value of the SHA256 algorithm are used (N=24) and the processing bit unit is 8 bits (W=8).

Referring to FIG. 10, each graph represents the number of hash calculations required to generate a unit firmware signature from multiple unit private keys and a probability of occurrence of that number. As described above, the number of hash calculations required to generate the unit firmware signature from the unit private keys may correspond to the digest.

As illustrated in FIG. 10, when the processing bit unit is 2 bits (1010), there is a high probability that 140 hash calculations need to be applied to generate a firmware signature corresponding to a private key may be the highest. On the other hand, if the processing bit unit is 8 bits (1020), it is most likely that 3000 hash calculations will be required to generate the firmware signature corresponding to the private key.

Referring to FIG. 11, each graph represents a probability of occurrence of a number of times a first number of hash calculations required to generate a unit firmware signature from a plurality of unit private keys and a number of hash calculations required to generate a plurality of unit checksums from a plurality of unit check keys. That is, it may be a graph that takes into account a number of hash calculations required to generate multiple unit checksums from multiple unit check keys.

As illustrated in FIG. 11, when the processing bit unit is 2 bits (1110), there is a high probability that approximately 145 hash calculations will need to be applied to generate a unit firmware signature and a unit checksum. However, if the processing bit unit is 8 bit (1120), it is most likely that about 3300 hash calculations will need to be applied to generate the unit firmware signature and the unit checksum.

When the processing bit unit is 2 bits, a first verification time may be required to verify a signature generated by performing the hash calculation 204 times, and a second verification time may be required to verify a signature generated by performing the hash calculation 108 times. In embodiments, a sum of the number of hash calculations performed to generate the signature and the number of hash calculations performed to verify the signature may be constant. Accordingly, the second verification time may be 1.5 times that of the first verification time due to a time difference required to perform the hash calculation to verify the signature.

Meanwhile, when the processing bit unit is 8 bits, a third verification time may be required to verify a signature generated by performing the hash calculation 5100 times, and a fourth verification time may be required to verify a signature generated by performing the hash calculation 1785 times. In this case, the fourth verification time may be 2.8 times that of the third verification time due to a time difference required to perform the hash calculation.

FIG. 12 illustrate graphs showing occurrence probability according to the number of hash calculations according to an embodiment.

Referring to FIG. 12, each graph represents probability of occurrence of a first number of hash calculations required to generate a firmware signature from a private key and a check key, and a second number of hash calculations required to verify the firmware signature.

As described above, a sum of the number of hash calculations performed to generate the signature and the number of hash calculations performed to verify the signature may be constant. Accordingly, as the number of hash calculations performed to generate a signature (signature generation) increases, the number of hash calculations performed to verify a signature (signature verification) may tend to decrease. As shown in FIG. 12, in both cases, i.e., when the processing bit unit is 2 bits and when the processing bit unit is 8 bits, as the number of hash calculations performed to generate a signature (signature generation) increases, the number of hash calculations performed to verify a signature (signature verification) may tend to decrease.

The signature generator 640 may be configured to require a certain number of hash calculations to generate a firmware signature by changing the digest. In embodiments, the number of hash calculations required to generate the firmware signature may be determined based on the digest and the checksum. Accordingly, cases where a verification time required to verify the firmware using the firmware signature is excessively long may be ruled out.

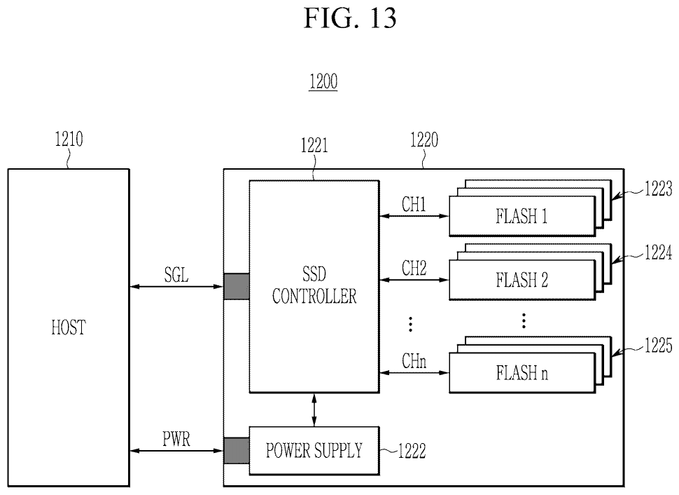

FIG. 13 illustrates a block diagram showing an example of applying a storage device according to an embodiment to an SSD (solid-state drive) system.

Referring to FIG. 13, the SSD system 1200 may include a host 1210 and an SSD 1220.

The SSD 1220 may include the firmware signature described with reference to FIG. 1 to FIG. 12. The SSD 1220 may exchange signals with the host 1210 through a signal connector SGL, and may receive power through a power connector PWR.

The SSD 1220 may receive a firmware image download command and a target firmware image to be downloaded via the signal connector SGL.

The SSD 1220 may include a SSD controller 1221, an auxiliary power supply 1222, and a plurality of memory systems 1223, 1224, and 1225. Each of the memory systems 1223, 1224, and 1225 may include one or more flash memory devices as a storage device. Furthermore, each flash memory device may include one or more dies DIE, and each of the dies DIE may have one or more blocks arranged thereon.

The SSD controller 1221 may communicate with the memory systems 1223, 1224, and 1225 through multiple channels Ch1, . . . , and Chn respectively. The SSD controller 1221 may perform verification of the firmware image within the SSD 1220. In some embodiments, the firmware image may include firmware data, a firmware signature, and a first public key. The SSD controller 1221 may generate a first candidate public key based on a first remaining number of hash calculations to derive the first public key from the firmware signature. The SSD controller 1221 may verify the firmware image by comparing the first candidate public key and the first public key. In some embodiments, the first remaining number may be less than or equal to a predetermined first threshold value. That is, because the sum of the number of hash calculations performed when generating the firmware signature and the number of hash calculations performed when verifying the firmware signature is constant, the firmware signature may be a value generated by performing a hash calculation that is greater than a preset value. For example, the first threshold may be determined based on an average of the number of hash calculations applied to generate a firmware signature from a private key corresponding to the memory system.

Accordingly, the SSD 1220 may reduce a time required to verify the firmware image.

In the above embodiments, at least one of the components, elements, modules and units (collectively “components” in this paragraph) represented by a block or an equivalent indication in the drawings including FIG. 6 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal memory or an external memory that is readable by at least one processor. For example, the at least one processor may invoke at least one of the one or more instructions stored in the memory, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While this disclosure has been described in connection with what is presently considered to be practical embodiments, it is to be understood that the disclosure is not limited to the disclosed embodiments, but, on the contrary, is intended to cover various modifications and equivalent dispositions included within the spirit and scope of the appended claims.

What is claimed is:

1. A method for signature generation, the method being executed by at least one processor, the method comprising:
obtaining a private key and a public key corresponding to the private key, the private key and the public key being associated with a storage device;
dividing the private key into a plurality of unit private keys based on a processing bit unit;
obtaining a first calculation number of hash calculations for deriving the public key from the private key based on the processing bit unit;
generating a first random number;
obtaining a first application number of hash calculations for deriving a plurality of unit firmware signatures based on the first random number, wherein each unit firmware signature is associated with a respective unit private key from the plurality of unit private keys based on the first random number;
determining whether a first remaining number that is a difference between the first application number and the first calculation number, is less than or equal to a preset first threshold; and
upon determining that the first remaining number is less that the preset first threshold, generating a firmware signature based on the plurality of unit firmware signatures.

2. The method of claim 1, further comprising:
based on the first remaining number being greater than the preset first threshold, generating a second random number;
obtaining a second application number of hash calculations for deriving the plurality of unit firmware signatures from the plurality of unit private keys based on the second random number;
upon determining that a second remaining number is less than or equal to the preset first threshold, generating the firmware signature based on the plurality of unit firmware signatures, wherein the second remaining number is the difference between the second application number and the first calculation number.

3. The method of claim 1, wherein the preset first threshold is greater than or equal to half of the first calculation number.

4. The method of claim 1, further comprising:
generating a plurality of unit check keys associated with the private key based on the first remaining number;
obtaining a third calculation number of hash calculations for deriving the public key from the plurality of unit check keys based on the processing bit unit;
obtaining a third application number of hash calculations for deriving a plurality of unit checksums associated with respective unit check keys from the plurality of unit check keys based on the first remaining number;
determining whether a first sum is less than or equal to a preset second threshold, wherein the first sum is a sum of a third remaining number and the first remaining number, and wherein the third remaining number is the difference between the third application number and the third calculation number; and
upon determining that the first sum is less than or equal to the preset second threshold, generating the firmware signature based on the plurality of unit firmware signatures and the plurality of unit checksums.

5. The method of claim 4, further comprising:
based on the first sum exceeding the preset second threshold, generating a third random number;
obtaining a fourth application number of hash calculations for deriving the plurality of unit firmware signatures from the plurality of unit private keys based on the third random number; and
upon determining that a third sum is less than or equal to the preset second threshold, generating the firmware signature based on the plurality of unit firmware signatures and the plurality of unit checksums, wherein the third sum is a sum of a fourth remaining number and the first remaining number, and wherein the fourth remaining number is a difference between the fourth application number and the third calculation number.

6. The method of claim 5, wherein the preset second threshold has a value that is greater than or equal to half of a sum of the first calculation number and the second calculation number.

7. The method of claim 1, wherein the first calculation number is determined based on Q=H(I∥u32str(q)∥u16str(D_MESG)∥C∥message), and
wherein I comprises at least one of a type of the hash calculation or the processing bit unit, u32str(q) is a value indicating a leaf position in a Merkle tree structure, u16str(D_MESG) is a value preset corresponding to each of a plurality of stages in the hash calculation, C is the first random number, and message is the firmware data.

8. The method of claim 1, wherein a first number of the plurality of unit private keys and a second number of the plurality of unit check keys are determined based on the processing bit unit and a number of valid bits.

9. A signature generation system comprising;
a random number generator configured to generate multiple random values;
a hash circuit configured to generate a first digest based on a first random value among the multiple random values and firmware data;
a key generator configured to obtain a first private key and a first public key, the first public key associated with the first private key, and the first private key and the first public key being associated wo firmware data;
a signature generator configured to:
calculate a first application number of hash calculations for deriving a first firmware signature from the first private key based on a first random number, and
based on the first application number is greater than or equal to a preset first threshold, generate a first firmware signature based on the first digest and the first private key; and
a storage device configured to store the first firmware signature and the first public key.

10. The signature generation system of claim 9, wherein the signature generator is further configured to:
generate a plurality of unit check keys corresponding to the first private key based on a first remaining number, the first remaining number being a difference between the first application number from a first calculation number, the first calculation number being a number of hash calculations for deriving the first public key from the first private key based on a processing bit unit, and
generate a plurality of unit checksums associated with a respective unit check key from the plurality of unit check based on the first remaining number.

11. The signature generation system of claim 10, wherein the signature generator is further configured to:
calculate a second calculation number of hash calculations for deriving the first public key from the plurality of unit check keys based on the processing bit unit, and
determine a sum of the first calculation number and the second calculation number based on the processing bit unit.

12. The signature generation system of claim 11, wherein the signature generator is further configured to:
calculate a second remaining number of hash calculations for deriving the first public key from the plurality of unit checksums, and
upon determining that the first remaining number and the second remaining number is less than or equal to the first threshold, generate the first firmware signature based on the first private key and the plurality of unit check keys.

13. The signature generation system of claim 12, wherein the first threshold is greater than or equal to half of a sum of the first calculation number and the second calculation number.

14. The signature generation system of claim 10, wherein the signature generator is further configured to:
divide the first private key into a plurality of unit private keys based on the processing bit unit, and
generate a plurality of unit firmware signatures associated with each unit private key from the plurality of unit private keys based on the first digest value, wherein a number of the plurality of unit private keys and a number of the plurality of unit check keys are determined based on the processing bit unit and a number of valid bits.

15. The signature generation system of claim 9, wherein the first digest is determined based on Q=H(I∥u32str(q)∥u16str(D_MESG)∥C∥message), and
wherein I comprises at least one of a type of the hash calculation or the processing bit unit for processing the firmware data, u32str(q) is a value indicating a leaf position in a Merkle tree structure, u16str(D_MESG) is a value preset corresponding to each of a plurality of stages in the hash calculation, C is the first random number, and message is the firmware data.

16. The signature generation system of claim 9, wherein the signature generator is further configured to:
generate a plurality of candidate firmware signatures associated with a respective random number from a plurality of random numbers based on each of the plurality of random numbers, and
determine, from the plurality of candidate firmware signatures, a first candidate firmware signature having a greatest application number of hash calculations as the first firmware signature.

17. The signature generation system of claim 9, wherein the storage device is further configured to:
generate a first candidate public key based on the first firmware signature, the firmware data, and the first random number, and
verify the firmware data based on a comparison between the first candidate public key and the first public key.

18. A storage device comprising:
a non-volatile memory comprising firmware data and a firmware signature generated based on a first private key; and
a storage controller configured to:
calculate a first remaining number of hash calculations for deriving a first public key associated with the first private key from the firmware signature based on the firmware data and a first random number,
generate a first candidate public key based on the firmware signature, the firmware data, and the first random number, and
verify the firmware data based on a comparison of the first candidate public key and the first public key, wherein the first remaining number is less than or equal to a preset first threshold.

19. The storage device of claim 18, wherein the preset first threshold is a first application number of hash calculations for deriving the firmware signature from the first private key.

20. The storage device of claim 18, further comprising:
one time programmable (OTP) memory configured to store the first public key.
